(19) United States
(12) Patent Application Publication
(10) Pub. No.: US 2015/0351417 A1
(43) Pub. Date: Dec. 10, 2015

(54) EDIBLE MATERIALS AND THEIR MANUFACTURE

(71) Applicant: Intercontinental Great Brands LLC, East Hanover, NJ (US)

(72) Inventor: Martyn ROBINSON, Birmingham (GB)

(21) Appl. No.: 14/408,929

(22) PCT Filed: Jun. 20, 2013
(86) PCT No.: PCT/GB2013/051610

§ 371 Date: Dec. 17, 2014

(30) Foreign Application Priority Data
Jun. 20, 2012 (GB) 1210872.6

(51) Int. Cl. A21D 13/00

(52) U.S. Cl. CPC A21D 13/0064; A21D 13/0061

(57) ABSTRACT

An edible material having a water activity not exceeding 0.8 is formed by admixture of a binding material and particles of baked farinaceous material. Suitably the particles of baked farinaceous material are particles of cake, and the binding material comprises caramel and a humectant, such as glycerine. Steps in the preparation of the edible material are: (a) providing a baked farinaceous material; (b) optionally, drying the baked farinaceous material; (c) mechanically processing the baked farinaceous material to form particles; (d) optionally, drying the particles of baked farinaceous material; and (e) admixing the particles of baked farinaceous material with a binding material to provide the edible material.

The present invention relates to edible materials, to products comprising such edible materials and to methods of providing such materials and products.

Confectionery products such as cakes and brownies are conventionally made by preparing an uncooked liquid mixture comprising eggs and flour, pouring the mixture into a suitable container and then baking the mixture. It is well known in the confectionery industry that the conventional baking process is inflexible, and that it is difficult to control this process to produce products with precise and consistent size, shape and weight.

US 2007/160713A describes a process for manufacturing brownies and other baked food products. The dry and wet ingredients for the brownie are mixed in a vertical mixer and the mixture is fed through an extruder. The extruded product is cut and then baked using defined baking conditions.

US 20110/38995A describes methods for making a food product such as a brownie. The method involves forming a mixture, extruding the mixture and baking.

It is an object of embodiments of the present invention to provide an edible material which has the desirable characteristics normally associated with cakes or brownies, but which is not produced by baking in the conventional manner, with its attendant drawbacks.

It is an object of embodiments of the invention to enable a manufacturer to control the size, weight and shape of confectionery products more effectively than a conventional baking process.

It is an object of embodiments of the invention to provide an edible material which will provide a confectionery product with a long shelf-life.

According to a first aspect of the present invention there is provided an edible material formed by admixture of a binding material and particles of baked farinaceous material, wherein the edible material has a water activity not exceeding 0.8.

By binding material in this specification we refer to a liquid (including a semi-solid continuous material) that can be mixed with the particles of baked farinaceous material. Suitably the binding material is a liquid when it is mixed with the particles. Suitably the binding material is a liquid with a viscosity in the range of from 1 to 500 Pa·s (Pascal-seconds) at a shear rate of 10 sec⁻¹ when the binding material is at the temperature at which it is mixed with the particles.

In embodiments of the invention the binding material is a liquid with a viscosity in the range of from 1 to 200 Pa·s at a shear rate of 10 sec⁻¹, when the binding material is at the temperature at which it is mixed with the particles.

In embodiments of the invention the binding material is a liquid with a viscosity in the range of from 2 to 100 Pa·s at a shear rate of 10 sec⁻¹, when the binding material is at the temperature at which it is mixed with the particles.

In embodiments of the invention the binding material is a liquid with a viscosity in the range of from 4 to 50 Pa·s at a shear rate of 10 sec⁻¹, when the binding material is at the temperature at which it is mixed with the particles.

It is intended that the binding material binds the particles of baked material together to form a solid or semi-solid mass. It is further intended that the mixture of the binding material and the particles of baked farinaceous material has a substantially uniform texture; in the sense that the cake material on the inside of a baked Madeira sponge cake is considered to have a uniform texture whereas a cereal bar composed of nuts and/or grains bound together by a syrup is not considered to have a uniform texture.

In some embodiments the binding material is a solid at ambient temperature and a liquid (including a semi-solid continuous material) at a higher temperature, at which it is admixed with the particles. Such products may have relatively firm eating properties. In such embodiments the binding material is at an elevated temperature when admixed with the particles. Firm eating properties may arise due to the re-solidification of the binding material, on cooling to ambient temperature after the admixing.

In some embodiments the binding material is a liquid (including a semi-solid continuous material) at ambient temperature, as well as at the temperature at which it is admixed with the particles (which may be at a higher temperature than ambient temperature, but is not necessarily so). Such products may have relatively soft eating properties. In such embodiments the binding material may suitably be at ambient temperature or at an elevated temperature when admixed with the particles.

Ambient temperature in this specification means 20° C. An elevated temperature in this specification is suitably a temperature in excess of 20° C.; typically up to 80° C.; more particularly a temperature in the range 25-70° C., suitably 30-60° C., and in some embodiments 35-50° C.

Many viscometers can subject a material to a shear rate of 10 sec⁻¹. For example a Brookfield DV-111 Ultra viscometer is one viscometer which may be employed for this purpose.

Baking or cooking the edible material according to the first aspect is not excluded. However in embodiments of the invention the edible material according to the first aspect may be provided without baking or cooking the edible material subsequent to admixture of the binding material and the particles of baked farinaceous material.

The edible material according to the first aspect may have a similar appearance to a cake or brownie produced by a conventional baking process.

The binding material may provide at least 5 wt % of the edible material. Suitably the binding material provides at least 10 wt % of the edible material, for example at least 15 wt % or at least 20 wt %.

The binding material may provide up to 45 wt % of the edible material. Suitably the binding material provides up to 40 wt % of the edible material, for example up to 35 wt % or up to 30 wt %.

In some embodiments the binding material may provide from 5 to 40 wt % of the edible material. Alternatively the binding material may provide from 5 to 35 wt % of the edible material, for example 5 to 30 wt %.

In alternative embodiments the binding material may provide from 10 to 45 wt % of the edible material. Alternatively the binding material may provide from 15 to 45 wt % of the edible material, for example 20 to 45 wt %.

The binding material may provide at least one liquid fat or oil, sugar source, humectant, hydrocolloid or flavouring or aroma component.

Suitable liquid fats or oils include fats or oils of plant origin; for example soybean oil, cottonseed oil, peanut oil, sunflower seed oil, rapeseed oil, olive oil, palm oil, coconut oil, palm kernel oil, cocoa butter and cocoa butter alternatives.

Cocoa butter alternatives include, butterfat, a cocoa butter equivalent (CBE), a cocoa butter replacer (CBR), a cocoa butter substitute CBS, (sometimes used interchangeably with CBR), a vegetable fat that is liquid at standard ambient temperature and pressure (SATP, 25° C. and 100 kPa) or any combination of the above.

CBEs are defined in Directive 2000/36/EC as complying with the following criteria:

a) they are non-lauric vegetable fats, which are rich in symmetrical monounsaturated triglycerides of the type POP, POSt and StOSt;

b) they are miscible in any proportion with cocoa butter, and are compatible with its physical properties (melting point and crystallisation temperature, melting rate, need for tempering phase);

c) they are obtained only by the processes of refining and/or fractionation, which excludes enzymatic modification of the triglyceride structure.

Suitable CBEs include illipe, Borneo tallow, tengkawang, palm oil, sal, shea, kokum gurgi and mango kernel or synthetic CBEs such as COBERINE® produced by Loders Croklaan, The Netherlands. CBEs may be used in combination with cocoa butter.

Suitable CBSs (or CBRs) include CBS laurics and CBS non-laurics. CBS laurics are short-chain fatty acid glycerides. Their physical properties vary but they all have triglyceride configurations that make them compatible with cocoa butter. Suitable CBSs include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS non-laurics include soya, cottonseed, peanut, rapeseed and corn (maize) oil.

Suitable vegetable fats are liquid at standard ambient temperature and pressure (SATP, 25° C. and 100 kPa). A liquid vegetable fat may be employed when a liquid chocolate composition is desired. Suitable vegetable fats include corn oil, cotton seed oil, rapeseed oil, palm oil, safflower oil, and sunflower oil.

The present invention is further applicable to compositions in which some or all of the fat is constituted by a partly or wholly non-metabolisable fat, for example Caprenin.

The binding material may comprise at least one sweetener. The at least one sweetener may be a bulk sweetener or an intense sweetener. Suitable bulk sweeteners include sucrose, invert sugar syrup, caramel, glucose, fructose, polydextrose, high fructose corn syrup, honey, maple syrup, agave syrup, jam, marmalade and sugar alcohols, for example glycerol, maltitol, isomalt, sorbitol, xylitol, lactitol, erythritol, galactitol, polyglycitol and mannitol.

The binding material may comprise a bulk sweetener in an amount that provides at least 5 wt % of the edible material. Suitably the binding material comprises a bulk sweetener in an amount that provides at least 10 wt % of the edible material, for example at least 15 wt %.

The binding material may comprise a bulk sweetener in an amount that provides up to 40 wt % of the edible material. Suitably the binding material comprises a bulk sweetener in an amount that provides up to 35 wt % of the edible material, for example up to 30 wt %.

In some embodiments the binding material may comprise a bulk sweetener in an amount that provides from 5 to 40 wt % of the edible material. In an alternative embodiment the binding material may comprise a bulk sweetener in an amount that provides from 10 to 30 wt % of the edible material, for example 15 to 30 wt %.

The binding material may comprise at least one intense sweetener, for example to alter the flavour or reduce the calorie value of the edible material. Suitable intense sweeteners are selected from, for example, aspartame, saccharin, sucralose, acesulfame-K, stevia and neohesperidine. An intense sweetener may be present in an amount of from 0.01 to 2 wt %.

The binding material may comprise at least one humectant. Suitable humectants include glycerine, propylene glycol, glyceryl triacetate, polyols, xylitol, maltitol, polymeric polyols, polydextrose, natural extracts of quillaia, lactic acid, and the like. Suitably the humectant is glycerine.

The binding material may comprise a humectant in an amount that provides at least 1 wt % of the edible material. Suitably the binding material comprises a humectant in an amount that provides at least 2 wt % of the edible product, for example at least 3 wt %.

The binding material may comprise a humectant in an amount that provides up to 10 wt % of the edible material. Suitably the binding material comprises a humectant in an amount that provides up to 8 wt %, for example up to 6 wt %.

In some embodiments the binding material comprises a humectant in an amount that provides from 1 to 10 wt % of the edible material, for example from 2 to 9 wt %.

The binding material may comprise at least one hydrocolloid. Suitable hydrocolloids include naturally occurring materials such as plant exudates, seed gums, and seaweed extracts or chemically modified materials such as cellulose, starch, and natural gum derivatives. Furthermore, suitable hydrocolloids can include pectin, gum arabic, acacia gum, alginates, agar, carageenans, guar gum, xanthan gum, locust bean gum, gelatine, gellan gum, galactomannans, tragacanth gum, karaya gum, curdlan, konjac, chitosan, xyloglucan, beta glucan, furcellaran, gum ghatti, tamarin, bacterial gums, modified natural gums such as propylene glycol alginate, carboxymethyl locust bean gum, low methoxyl pectin, and combinations thereof. Further suitable hydrocolloids include modified celluloses for example microcrystalline cellulose, carboxymethylcellulose (CMC), methylcellulose (MC), hydroxy-propylmethylcellulose (HPMC), hydroxypropylcellulose (HPC), and combinations thereof.

The binding material may comprise at least one flavouring and/or aroma component. Suitable flavourings and/or aroma components include herbs, spices, vanilla, fruits, nuts, aromatic vegetables, oleoresins, fruit juices or extracts, tea, coffee, cocoa, chocolate, carob, chilli, cinnamon, essences, essential oils or concentrates derived from any of the above; and synthetic flavouring compounds.

In some embodiments the binding material comprises caramel. Suitably the binding material comprises caramel and a humectant, for example the binding material may comprise caramel and glycerine.

By caramel in this specification, unless otherwise stated we mean to refer to a traditional confectionery caramel comprising a bulk sweetener, a fat and a protein (usually a dairy fat/protein), which have been mixed together and caramelised, and not a clear “sugar and water only” caramel.

In alternative embodiments the binding material comprises chocolate. Suitably the binding material comprises chocolate and invert sugar syrup. Alternatively the binding material may comprise chocolate and caramel. Furthermore the binding material may comprise chocolate, caramel and a humectant, for example the binding material may comprise chocolate, caramel and glycerine.

The term chocolate in the context of the present invention is not restricted by the various definitions of chocolate provided by government and regulatory bodies. Chocolate herein is simply a product that contains a fat phase and which is obtained from cocoa products and sweeteners. The fat may be cocoa butter, butterfat, a cocoa butter equivalent (CBE), a cocoa butter substitute (CBS), a vegetable fat that is liquid at ambient temperature or any combination of the above.

“Chocolate” in the context of the present invention includes dark, milk, white, compound chocolate and any other confectionery mass which is solid at ambient temperature and contains fat (e.g. cocoa butter or cocoa butter substitute) and one or more components derived from cocoa beans (e.g. cocoa powder). A sweetener (e.g. sucrose) is typically also contained in the chocolate. Other optional components include milk components (e.g. milk fat and milk powder).

The edible material of the present invention comprises particles of baked farinaceous material. By baked farinaceous material we mean to refer to any farinaceous material which has undergone a baking process. Suitable examples include cake, biscuit, cookie, cracker, bread, doughnut, pudding and pastry. By particles of baked farinaceous material we mean to refer to a baked farinaceous material that has been mechanically processed to obtain particles. Suitable mechanical processes may include blending, crushing, grinding, cutting or crumbing. In some embodiments the particles of baked farinaceous material are particles of cake. The particles of baked farinaceous material may be dried. For example a suitable drying procedure may comprise drying in an oven at a moderate temperature, for example 60-120° C., for 5-30 minutes. Alternatively the particles of baked material may be used without having undergone a drying procedure.

The size of the particles of baked farinaceous material is not believed to be critical. However, the particles of baked farinaceous materials may suitably be as stated below.

In some embodiments the particles of baked farinaceous materials have an average particle size of up to 10 mm. Suitably the particles of baked farinaceous materials may have an average particle size of up to 8 mm, for example up to 6 mm. In some embodiments the particles of baked farinaceous materials have an average particle size of up to 4 mm.

In some embodiments the particles of baked farinaceous materials have an average particle size of at least 1 mm, for example at least 1.5 mm, for example at least 2 mm.

In some embodiments at least 90 wt %, suitably at least 95 wt %, of the particles of baked farinaceous material have a particle size of up to 10 mm; suitably up to 8 mm; suitably up to 6 mm; and in some embodiments up to 4 mm.

In some embodiments at least 90 wt %, suitably at least 95 wt %, of the particles of baked farinaceous material have a particle size of at least 1 mm; suitably at least 1.5 mm; and in some embodiments at least 2 mm.

Particle size as defined herein is measured by conventional grading sieves.

In embodiments of the invention the particles have random shapes, for example caused by comminuting a larger baked article.

The particles of baked farinaceous material may provide at least 40 wt % of the edible material. Suitably the particles of baked farinaceous material may provide at least 50 wt % of the edible material, for example at least 60 wt %.

The particles of baked farinaceous material may provide up to 95 wt % of the edible material. Suitably the particles of baked farinaceous material may provide up to 85 wt % of the edible material, for example up to 80 wt %.

In some embodiments the particles of baked farinaceous material may provide from 40 to 60 wt % of the edible material. Alternatively the particles of baked farinaceous material may provide from 45 to 55 wt % of the edible material.

In alternative embodiments the particles of baked farinaceous material may provide from 60 to 90 wt % of the edible material. Alternatively the particles of baked farinaceous material may provide from 65 to 85 wt % of the edible material, for example from 70 to 80 wt %.

The edible material comprising binding material and particles of baked farinaceous material suitably has a water content in the range of from 4 to 30 wt % of the edible material, for example from 6 to 25 wt %.

The edible material may contain further edible substances. Suitable further edible substances described with respect to the second aspect are also referred to here. In some embodiments the binding material and the particles of baked farinaceous material provide at least 70 wt % of the edible material. Alternatively the binding material and the particles of baked farinaceous material provide at least 80 wt % of the edible material, for example at least 90 wt %. In some embodiments the edible material is substantially composed of binding material and particles of baked farinaceous material.

The edible material of the first aspect has a water activity not exceeding 0.8. Suitably the edible material has a water activity not exceeding 0.75, for example not exceeding 0.7.

Water activity measurements of the edible materials described herein were obtained at 25° C. using a Novatron Novasina water activity measurement device which uses the resistive-electrolytic measurement principle.

A water activity not exceeding 0.8 is believed to contribute to the improved shelf-life of products comprising the edible material of the present invention compared to cakes or brownies produced using conventional techniques. Lower water activities, not exceeding 0.75 and not exceeding 0.7, may offer further benefits.

In some embodiments, the edible material formed by admixture of a binding material and particles of baked farinaceous material suitably has a density of at least 1.0 g cm⁻³, for example at least 1.1 g cm⁻³.

In alternative embodiments, the edible material formed by admixture of a binding material and particles of baked farinaceous material has a density of up to 1.0 g cm⁻³, for example up to 0.9 g cm⁻³.

In one embodiment of the first aspect of the present invention, there is provided an edible material formed by admixture of a binding material and particles of baked farinaceous material, wherein the binding material comprises 5 to 45 wt % of the edible material and the particles of baked farinaceous material comprise from 40 to 90 wt % of the edible material; the edible material having a water content of from 4 to 30 wt % and a water activity not exceeding 0.8.

In another embodiment of the first aspect of the present invention, there is provided an edible material formed by admixture of a binding material and particles of baked farinaceous material, wherein the binding material comprises 10 to 40 wt % of the edible material, the binding material comprises a humectant in an amount that provides from 1 to 10 wt % of the edible material, and the particles of baked farinaceous material comprise from 40 to 90 wt % of the edible material; the edible material having a water content of from 5 to 25 wt % and a water activity not exceeding 0.8.

Suitable characteristics of the edible material according to the first aspect will now be described.

Suitably the edible material is soft and therefore easy for a consumer to bite through.

Suitably the edible material is moist so that a consumer would perceive a texture of a pleasantly moist nature.

Suitably the edible material is cohesive and therefore holds together well during mastication.

Suitably the edible material does not have a gritty, grainy, crunchy or crispy texture (though it could contain gritty, grainy, crunchy or crispy inclusions as described later).

In some embodiments of the first aspect, the edible material may be a sweet-tasting confectionery material, for example similar in taste and eating qualities to a cake or a brownie.

In some embodiments of the first aspect the edible material may be a savoury material. Suitably the savoury material comprises no or only a low level of a source of sweetness. The savoury material may comprise further ingredients. The further ingredients may include natural flavourings and artificial flavourings. Suitable further ingredients include yeast, yeast extract, seasonings (including salt), spices, cheese, cheese flavouring, butter, oil, nut flavouring (for example nut paste or nut butter), stock concentrates and glutamates. The further ingredients may be selected in order to provide particular flavours or flavour combinations. Suitable flavours include umami, smoky, meaty, cheesy, bouillon, salty and spicy flavours.

According to a second aspect of the present invention there is provided an edible product comprising edible material according to the first aspect. Suitable forms of the edible product include a tablet, slab, bar, lollipop, truffle, biscuit (cookie′ in US terminology), biscuit bar, coated biscuit bar, sandwich biscuit bar, cake (including carrot cake), cake bar, coated cake bar, sandwich cake bar, pudding, muffin, cookie, filled shell, madeleine, scone, doughnut, dumpling, loaf, tart and pie.

The edible product of the second aspect suitably has a water activity not exceeding 0.8. In embodiments of the invention the edible product has a water activity not exceeding 0.75, for example not exceeding 0.7.

The first aspect and the optional features of the first aspect stated above (whether product features or method features) are also to be taken as optional features of the second aspect unless otherwise stated. Conversely the second aspect and the optional features of the second aspect (whether product features or method features) are also to be taken as optional features of the first aspect unless otherwise stated.

The edible product may comprise further edible substances additional to those comprised by the cake material. Such materials may be provided in additional phases. Such further edible substances include nuts, nut pastes, chocolate, chocolate derivatives, fruit (including dried fruit pieces and fruit pastes), grains, biscuit (cookie′ in US terminology), cake, wafer, vegetables (including dried vegetable pieces and vegetable pastes), jam, marmalade, nougatine, truffle, frangipane, frosting, buttercream filling, cheese, cream or other soft cheese filling and caramel.

In some embodiments the further edible substances may be present as inclusions in the edible material of the first aspect. Therefore the edible product may be formed by admixture of a binding material, particles of baked farinaceous material and further edible substances.

It will be appreciated that adding further edible substances may change the characteristics of the edible material. The suitable characteristics of an edible product comprising further edible substances may not be the same as the suitable characteristics of the edible material described above with respect to the first aspect. For example, in one embodiment the edible material comprising further edible substances may have a gritty, grainy, crunchy or crispy texture.

The edible product may comprise a coating. Suitable coatings include chocolate-based or other cocoa-containing coatings, yoghurt-based coating, panned-sugar/polyol coatings, icing, a cereal layer and a biscuit layer. It may be a sweetener-based coating, as a frosting. The coating may further comprise a barrier layer between the coating and the edible product. The barrier layer may prevent or retard moisture migration between the edible product and the coating.

The edible product may be packaged. Suitable packaging may be reclosable or not reclosable (or resealable or not resealable). Suitable packaging would be known to a person skilled in the art.

A packaged edible product may be provided in a form and size intended for a single serving. Suitably a single serving may have a weight in the range of from 10 g to 200 g. Suitably a single serving of the edible product may be contained in a non-reclosable or non-resealable package.

In some embodiments the packaged edible product may be provided in a form and size intended to provide multiple servings. Suitably the multiple serving of the edible product may have a weight greater than 100 g. The multiple serving of the edible product may be one piece. Suitably the one piece of edible product may have defined portions intended to be broken or torn off the main body of the edible product to provide a serving of the edible product. A suitable form of the one piece of edible product may be a tablet or block. The term tablet is known in the art to refer to a substantially flat piece of edible product with portions, for example squares, defined by grooves in the edible product. Suitably the multiple serving of the edible product may be contained in a reclosable or resealable package.

In some embodiments a multiple serving of the edible product may be provided in bite-size pieces. Suitably the bite-size pieces may have a weight in the range of from 1 g to 20 g. The bite-size pieces may be individually wrapped. Alternatively the bite-size pieces may not be individually wrapped. A plurality of bite-size pieces may be contained in a suitable box or package. The box or package may be reclosable or resealable.

According to a third aspect of the present invention there is provided a method of producing an edible material comprising binding material and particles of baked farinaceous material, the method comprising:
(a) providing a baked farinaceous material;
(b) optionally, drying the baked farinaceous material;
(c) mechanically processing the baked farinaceous material to form particles;
(d) optionally, drying the particles of baked farinaceous material; and
(e) admixing the particles of baked farinaceous material with a binding material to provide the edible material.

The first aspect, the second aspect and the optional features described with reference to the first aspect or the second aspect as stated above (whether product features of method features) are also to be taken as optional aspects of the third aspect unless otherwise stated. Conversely the third aspect and the optional features of the third aspect (whether product features or method features) are also to be taken as optional features of the first or second aspect unless otherwise stated.

In particular the viscosity and temperature definitions stated above in relation to the first aspect apply.

Thus in some embodiments of the invention of this third aspect the viscosity of the binding material when admixing takes place is in the range from 1 to 500 Pa·s at a shear rate of 10 sec⁻¹_{.}

In some embodiments of the invention of this third aspect the viscosity of the binding material when admixing takes place is in the range from 1 to 200 Pa·s at a shear rate of 10 sec⁻¹.

In some embodiments of the invention of this third aspect the viscosity of the binding material when admixing takes place is in the range from 2 to 100 Pa·s at a shear rate of 10 sec⁻¹.

In some embodiments of the invention of this third aspect the viscosity of the binding material when admixing takes place is in the range from 4 to 50 Pa·s at a shear rate of 10 sec⁻¹.

In some embodiments of the invention of this third aspect the binding material is at a temperature in the range from ambient temperature to an elevated temperature, when admixed with the particles.

In some embodiments of the invention of this third aspect the binding material is at a temperature in the range 25-70° C., when admixed with the particles.

In some embodiments of the invention of this third aspect the binding material is at a temperature in the range 30-60° C., when admixed with the particles.

In some embodiments of the invention of this third aspect the binding material is at a temperature in the range 35-50° C., when admixed with the particles.

In some embodiments of the invention the temperature of the binding material when admixing takes place is in the range from 20-80° C. and the viscosity of the binding material when admixing takes place is in the range from 1 to 500 Pa·s at a shear rate of 10 sec-1.

Step (c) involves mechanically processing the baked farinaceous material to form particles. The techniques for mechanically processing the baked farinaceous material referred to in relation to the first aspect of the present invention are also referred to in relation to this third aspect. The features of the particles of baked farinaceous material referred to in relation to the first aspect of the present invention are also referred to in relation to this third aspect.

Steps (c) and (e) may be carried out in different equipment for mechanically processing and mixing the materials. In some embodiments steps (c) and (e) may be carried out in the same equipment for mechanically processing and mixing the materials, for example without removal of the crumbs before the addition of the binding material.

In some embodiments the baked farinaceous material and the binding material may be introduced into the equipment for mechanically processing and mixing the materials before mechanical processing, step (c) and step (e) may then be carried out simultaneously. For example, the binding material may be introduced into the equipment for mechanically processing and mixing the materials before the baked farinaceous material.

Step (e) involves admixing a binding material and the particles of baked farinaceous material to provide an edible material. The admixing may be carried out by machine or alternatively the admixing may be carried out by hand or by any other means known in the art.

Suitably the edible material provided by the method of the third aspect is not cooked or baked subsequent to step (e).

According to a fourth aspect of the present invention there is provided a method of producing an edible product using an edible material produced according to the method of the third aspect, the method comprising:

(1) providing an edible material by the method of the third aspect

(2) forming the edible material into an edible product using a forming process.

Step (2) involves forming the edible material into an edible product using a forming process. By forming we mean to refer to changing the physical form of the edible material, such as changing the shape of the edible material or adding further edible substances to the edible material. Forming may involve both adding further edible substances to the edible material and changing the shape of the edible material. The forming process may be performed in one step. Alternatively forming may be performed in more than one step. The suitable forms of the edible product referred to in relation to the second aspect of the present invention are also referred to in relation to this fourth aspect.

Step (2) may involve a process of shaping the edible material into a desired shape using a suitable forming process. Suitable processes for obtaining the desired shape include extrusion, shaping, stamping, pressing, chain forming, drop-rolling, cold-stamping, micro-capillary extrusion, pulse extrusion, moulding, aeration, depositing and sheeting and cutting. Suitably the edible material holds its shape once formed.

An advantage of the edible material of the present invention is that it may be formed into shapes that would be difficult or impossible to obtain with, for example, a cake or brownie prepared using conventional techniques. Such shapes include spheres. To obtain such shapes by conventional techniques, a cake or brownie may have to be cut and the excess material discarded. Therefore it will be appreciated that some embodiments of the edible material and methods of the present invention have the advantage of reducing wastage in the production of edible products.

Step (2) may involve adding further edible substances to the edible material. The further edible substances may be added during a process which also shapes the product. Suitable examples of processes that shape and/or add further edible substances to the edible material include co-extrusion internal, co-extrusion external, chocolate panning, sugar panning and cluster forming. For example the edible material may be co-extruded with a further edible substance so that the edible material encases the further edible substance. Alternatively the edible material may be co-extruded with a further edible substance so that the edible material is encased by the further edible substance. The edible material may be formed into an edible product by micro-capillary extrusion of a further edible substance inside the edible material so that tubes of further edible material are formed within the edible material.

The edible product may be a slab or sheet, which is cut into individual pieces, for example portion sized pieces which may suitably be from 30 g to 100 g in weight. The pieces may be topped or enveloped by a coating, for example icing (frosting), yoghurt coating, chocolate or chocolate-flavour coating, nuts, fruit or the like.

In some embodiments the edible product may have the form of alternating layers of the edible material and a further edible substance, for example a ‘sandwich’ of a layer of edible material between two layers of biscuit or wafer. Alternatively the edible product may be a sandwich of a layer of biscuit or wafer between two layers of edible material. A further alternative may be a layer of biscuit or wafer encased by the edible material.

The further edible substances may be added to the edible material prior to shaping the edible material. Alternatively, the further edible substances may be added to the edible material after shaping the edible material. The further edible substances may be added during the admixture of the binding material and the particles of baked material.

Step (2) may involve an additional step of coating the edible product after shaping. A suitable coating may be a chocolate-based other cocoa-containing coating. The coating may partially cover the edible product. In alternative embodiments the coating may completely cover or enclose the edible product. Suitable techniques for applying a coating to the edible product include dipping, spraying, enrobing, panning, in-moulding or topping.

Suitably step (2) does not involve a cooking or baking process.

An advantage of the method of the fourth aspect wherein step (2) does not involve a baking step is that the edible product can be coated without the need for a post-baking cooling step. In particular, coating the edible product with a chocolate-based coating would require a post-baking cooling step if a baking step was performed directly before the coating step. The absence of a cooling step simplifies the production process and therefore improves its efficiency.

It is intended that by varying the different components of the edible material described above, different desirable characteristics of an edible product can be provided. For example an edible product can be provided that mimics the taste and texture of a cake or brownie produced by conventional methods. In other words, a consumer's sensorial experience of the edible product is intended to be similar to that of a cake or brownie.

Another advantage of using the methods of the present invention is that a single supply of particles of baked farinaceous material can be used in many different processes to produce different edible materials and/or products by varying the other components of the mixture. This allows the baking and mechanical processing of the baked farinaceous material to produce the particles of baked farinaceous material to be performed at one production facility which can supply the particles of baked farinaceous material to many other production facilities. As a result these other production facilities would not require their own baking equipment, saving capital investment and running costs.

The first aspect, the second aspect, the third aspect and the optional features described with reference to the first aspect or the second aspect or the third aspect as stated above (whether product features of method features) are also to be taken as optional aspects of the fourth aspect unless otherwise stated. Conversely the fourth aspect and the optional features of the fourth aspect (whether product features or method features) are also to be taken as optional features of the first or second or third aspect unless otherwise stated.

In a fifth aspect of the present invention there is provided an edible material formed by admixture of a binding material and particles of baked farinaceous material, wherein the binding material provides from 5 to 45 wt % of the edible material and the particles of baked farinaceous material provide from 40 to 90 wt % of the edible material; the edible material having a water content of from 4 to 30 wt % and a water activity not exceeding 0.8. In a sixth aspect of the present invention there is provided an edible product comprising an edible material according to the fifth aspect.

In a seventh aspect of the present invention there is provided an edible material formed by admixture of a binding material and particles of baked farinaceous material, wherein the binding material provides from 5 to 45 wt % of the edible material, the binding material comprises a humectant in an amount that provides from 1 to 10 wt % of the edible material, the binding material comprises a bulk sweetener in an amount that provides from 5 to 40 wt % of the edible material, and the particles of baked farinaceous material provide from 40 to 90 wt % of the edible material; the edible material having a water content of from 5 to 25 wt % and a water activity not exceeding 0.8.

In an eighth aspect of the present invention there is provided an edible product comprising an edible material according to the seventh aspect.

The first aspect, the second aspect, the third aspect the fourth aspect and the optional features described with reference to the first aspect or the second aspect or the third aspect or the fourth aspect as stated above (whether product features of method features) are also to be taken as preferred aspects of any or each of the fifth, sixth, seventh or eighth aspects unless otherwise stated. Conversely the fifth, sixth, seventh or eighth aspects and the optional features of the fifth, sixth, seventh or eighth aspects (whether product features or method features) are also to be taken as optional features of the first, second, third or fourth aspect unless otherwise stated.

Aspects of the present invention will now be further described, by way of example only.

### EXAMPLE 1

### Brownie

An eggless chocolate cake was prepared using the ingredients in Table 1.

TABLE 1

| | g | wt % |
|---|---|---|
| Wheat flour | 450 | 35.0 |
| Sugar | 300 | 23.3 |
| Water | 300 | 23.3 |
| Oil | 125 | 9.7 |
| Cocoa | 60 | 4.7 |
| Vinegar | 20 | 1.6 |
| Baking powder | 10 | 0.8 |
| Bicarbonate of soda | 10 | 0.8 |
| Vanilla essence | 10 | 0.8 |
| Total | 1285 | 100 |

The dry ingredients were placed in a mixer and the wet ingredients added slowly and combined. The mixture was scraped down and mixed at a medium speed for 1 minute. The mixture was then placed in five round baking tins (480 g) and baked in an oven at 190° C. for 40 minutes. The cakes were then stood at ambient temperature for 5 minutes, turned out of the baking tins and stood at ambient temperature for a further 5 minutes. The cakes were then crumbed using a Hobart mixer with a paddle to provide a fine crumb that passed through a 2 mm sieve. The crumb was dried in an oven at 100° C. for 20 minutes. The crumb was then cooled and stored in containers until required.

The Brownie was prepared using the ingredients in Table 2.

TABLE 2

| | g | wt % |
|---|---|---|
| Cake crumb (Table 1) | 1600 | 71 |
| Soft caramel | 400 | 18 |
| Glycerine | 40 | 1.8 |
| Salt | 2.4 | 0.1 |
| Invert sugar | 60 | 2.7 |
| Deodorized cocoa liquor | 80 | 3.6 |
| Vanilla essence | 2.4 | 0.1 |
| Icing sugar | 60 | 2.7 |
| Total | 2245 | 100 |

Deodorized cocoa liquor (that is, cocoa mass) refers to cocoa bean which has been ground and refined to include both cocoa butter and non-fat cocoa solids, then heat treated to remove volatiles and odours. The ingredients, including the caramel warmed to a liquid state, were mixed together in a Hobart mixer then stored in a cupboard at approximately 40° C. This mixture was then passed through a hand crank sausage machine comprising a 20 mm circular nozzle. The extruded masses of 320 mm length were deposited onto silicone paper and stored in a sealed bag at 15° C. The extruded masses had a water activity (Aw) of 0.678. The following day the extruded masses were cut, enrobed in chocolate to give a coating of approximately 25 wt % of the finished product and cooled to provide the brownie product.

### EXAMPLE 2

### Cake with Truffle Texture

A cake was prepared using the ingredients in Table 3.

TABLE 3

| | g | wt % |
|---|---|---|
| Biscuit flour | 350 | 22.80 |
| Sugar | 200 | 13.03 |
| Invert syrup | 100 | 6.51 |
| 42DE glucose | 250 | 16.29 |
| Liquid egg | 100 | 6.51 |
| Butter | 200 | 13.03 |
| Cocoa powder | 50 | 3.26 |
| Glycerine | 279 | 18.18 |
| Salt | 5 | 0.33 |
| Bicarbonate of soda | 0.5 | 0.03 |
| Vanillin | 0.5 | 0.03 |
| Total | 1535 | 100.00 |

The weight of the cake after baking the mixture of the ingredients in Table 3 was 1454 g. The cake was then crumbed using a Hobart mixer until the particle size of the crumbs appeared to not be reduced further by continued mixing. The average particle size was about 4 mm.

A cake product was prepared using the ingredients in Table 4.

TABLE 4

| | g | wt % |
|---|---|---|
| Cake crumb (Table 3) | 14.45 | 85 |
| Rumble syrup 44 | 1.53 | 9 |
| Glycerine | 0.96 | 5.63 |
| Chocolate | 0.06 | 0.37 |
| Total | 17.00 | 100 |

The ingredients were mixed together in a Hobart mixer then spread out onto a sheet and cut into portions 27 mm long, 19 mm wide and 6 mm thick, having a weight of approximately 4 g.

This recipe could be modified by the inclusion of, for example, nuts, nut pastes, chocolate, chocolate derivatives, fruit (including dried fruit pieces and fruit pastes), grains, biscuit, cake, wafer, vegetables (including dried vegetable pieces and vegetable pastes), jam, marmalade, nougatine, truffle, frangipane, frosting, buttercream filling, cream cheese filling and caramel.

### EXAMPLE 3

### Brownie Cake with Vanilla Crème Filling

A brownie mixture was prepared using the ingredients in Table 5. The ingredients included cake crumbs prepared as described in Example 1.

TABLE 5

| | g | wt % |
|---|---|---|
| Cake crumb (Table 1) | 1310 | 67 |
| Soft caramel | 400 | 20.5 |
| Glycerine | 40 | 2.0 |
| Salt | 2.4 | 0.1 |
| Invert sugar | 60 | 3.1 |
| Deodorized liquor | 80 | 4.1 |
| Vanilla essence | 2.4 | 0.1 |
| Icing sugar | 60 | 3.1 |
| Total | 1954.8 | 100 |

The ingredients in Table 5 were mixed together then pushed through the outer ring of a co-extrusion die head to form a tube. These tubes were cut into lengths of approximately 50 mm, stood on their ends and refrigerated to harden. The tubes were removed from the refrigerator and vanilla crème filling was then hand piped into the tubes while stood on their ends. The filled tubes were then returned to the refrigerator to harden. Once sufficiently stable, the tubes were enrobed with chocolate to provide a chocolate coated, vanilla crème filled brownie cake.

1: An edible material formed by admixture of a binding material and particles of baked farinaceous material, wherein the edible material has a water activity not exceeding 08.

2: An edible material according to claim 1, wherein the binding material provides 5 to 45 wt % of the edible material and the particles of baked farinaceous material provide from 40 to 90 wt % of the edible material; the edible material having a water content of from 4 to 30 wt % and a water activity not exceeding 0.8.

3: An edible material according to claim 1, wherein the binding material comprises a humectant in an amount that provides from 1 to 10 wt % of the edible material.

4: An edible material according to claim 1, wherein the humectant is glycerine.

5: An edible material according to claim 1, wherein the binding material comprises caramel.

6: An edible material according to claim 1, wherein the edible material has a substantially uniform texture throughout.

7: An edible material according to claim 1, wherein the particles of baked farinaceous material are particles of cake.

8: An edible product comprising an edible material according to claim 1.

9: A method of producing an edible material comprising binding material and particles of baked farinaceous material, the method comprising:
(a) providing a baked farinaceous material;
(b) optionally, drying the baked farinaceous material;
(c) mechanically processing the baked farinaceous material to form particles;
(d) optionally, drying the particles of baked farinaceous material; and
(e) admixing the particles of baked farinaceous material with a binding material to provide the edible material.

10: A method according to claim 9 wherein the temperature of the binding material when admixing takes place is in the range from 20-80° C. and the viscosity of the binding material when admixing takes place is in the range from 1 to 500 Pa·s at a shear rate of 10 sec⁻¹.

11: A method of producing an edible product using an edible material produced according to claim 9, the method comprising:
(1) providing an edible material by the method of claim 9 or 10;
(2) forming the edible material into an edible product using a process.

12: The method according to claim 11, wherein the method comprises an additional step of coating the edible product with a coating material.

13: The method according to claim 9, wherein step (2) does not involve a cooking or baking process.

14: An edible material formed by admixture of a binding material and particles of baked farinaceous material, wherein the binding material provides from 5 to 45 wt % of the edible material and the particles of baked farinaceous material provide from 40 to 90 wt % of the edible material; the edible material having a water content of from 4 to 30 wt % and a water activity not exceeding 0.8.

15: An edible material formed by admixture of a binding material and particles of baked farinaceous material, wherein the binding material provides from 5 to 45 wt % of the edible material, the binding material comprises a humectant in an amount that provides from 1 to 10 wt % of the edible material, the binding material comprises a bulk sweetener in an amount that provides from 5 to 40 wt % of the edible material, and the particles of baked farinaceous material provide from 40 to 90 wt % of the edible material; the edible material having a water content of from 5 to 25 wt % and a water activity not exceeding 0.8.
